(19) United States
(12) Patent Application Publication
(10) Pub. No.: US 2026/0098558 A1
(43) Pub. Date: Apr. 9, 2026

(54) AGGREGATE DE-BLINDING ROD ASSEMBLY

(71) Applicant: David K. Liland, New Bern, NC (US)

(72) Inventor: David K. Liland, New Bern, NC (US)

(21) Appl. No.: 19/348,448

(22) Filed: Oct. 2, 2025

Related U.S. Application Data
(60) Provisional application No. 63/702,932, filed on Oct. 3, 2024.

(51) Int. Cl. F16B 13/04; B07B 1/54

(52) U.S. Cl. CPC F16B 13/04; B07B 1/54

(57) ABSTRACT

Improved de-blinding rod assemblies for aggregate processing are provided. In one embodiment, uni-directional locking dowels are employed to create connections that resist backing out or loosening during vibration, enhancing assembly integrity. Another embodiment provides a unitary de-blinding rod formed as a single molded piece, which simplifies assembly, increases mass for improved screen clearing efficiency, and enhances operational safety. The rod terminates in a single-unit connecting bar assembly that reduces reliance on multiple dowels for securing branches and sleeves. The locking dowels exhibit an improved design preventing dislodgement during high-vibration conditions, thereby improving durability and reducing maintenance.

### CROSS-REFERENCE TO RELATED APPLICATIONS

This application claim priority to U.S. Provisional Application No. 63/702,932, filed on Oct. 3, 2024, which is incorporated herein by reference in its entirety.

### TECHNICAL FIELD

The present disclosure relates generally to the field of aggregate processing equipment, and more specifically to improved designs of de-blinding rods and de-blinding rod assemblies used with vibrating aggregate processing machines. In particular, the disclosure focuses on enhanced structural configurations and fastening mechanisms for de-blinding rods and associated locking dowels, aimed at improving material removal efficiency and operational stability.

### BACKGROUND

Aggregates produced through aggregate processing have been extensively utilized in construction projects, particularly following the start of the United States interstate highway system during the mid-20th century. As a result, quality standards governing aggregate materials are stringent. Production of high-quality aggregate commonly involves subjecting crushed stone to a screening process. Such processes typically employ vibrating screens to separate material based on particle size. In certain instances, however, accumulations of material may develop on the vibrating screen, which can impair efficiency of the screening operation.

One of the primary causes of downtime and lost production in aggregate screening is referred to as “blinding.” Blinding occurs when the screen mesh openings on a vibrating screen are blocked by the material that is being screened. This prevents material from passing through the vibrating screen during the sifting process, adding to maintenance expenses.

To minimize blinding, de-blinding rods have been installed on top of the vibrating screen. The de-blinding rods are configured to move dynamically in conjunction with the vibrating screen. This movement helps dislodge particles that may otherwise accumulate, clog apertures, and block material flow, thereby assisting in the prevention of clogging within the screen structure.

De-blinding rod assemblies employed in aggregate processing systems are commonly constructed from multiple interconnected portions. Conventionally, such portions are joined using standard dowels. However, during operation, the assemblies are subjected to substantial vibrational forces. Over time, such vibrational loading can cause the dowels to fracture or to loosen and disengage from the assembly. Either occurrence may result in separation or failure of the de-blinding rod. Failure of a de-blinding rod may necessitate system downtime for repair or replacement and may further result in collateral damage to other components of the aggregate processing system, thereby undermining the intended advantages of incorporating the de-blinding rods. Thus, an improved design for de-blinding rods is needed.

### SUMMARY

Described herein is an improved design of de-blinding rods and de-blinding rod assemblies.

This summary is provided to introduce in a simplified form concepts that are further described in the following detailed descriptions. This summary is not intended to identify key features or essential features of the claimed subject matter, nor is it to be construed as limiting the scope of the claimed subject matter.

The present disclosure describes implementations that relate to an improved design of de-blinding rods and de-blinding rod assemblies. According to one or more embodiments, the improved de-blinding rod designs described herein may comprise a connecting bar assembly that is heavier and covers more surface area, thereby allowing for more material buildup to be removed. In certain embodiments, the dowels configured to secure portions of the de-blinding bar exhibit a defined geometry such that, once installed, the dowels are resistant to dislodgement during operation.

In various embodiments, an improved de-blinding rod assembly for aggregate processing is disclosed. The assembly may comprise one or more connecting sleeves, branch portions, and trunk portions which are secured together using unidirectional locking dowels. The de-blinding rod assembly may further comprise an extension bar and an attachment section for coupling to a vibrating aggregate processing machine. In one aspect, the attachment section may include a ring-shaped portion, though alternative geometries are contemplated.

In accordance with another aspect of the present disclosure, an improved unidirectional locking dowel is provided. The locking dowel may include a shaft, a flat base disposed at one end, and a tapered or shouldered head disposed at the opposite end, each configured to prevent disengagement upon insertion through the apertures of a connecting sleeve. This configuration inhibits vibrational loosening during operation, thereby maintaining secure assembly until intentional removal. The locking dowels may be fabricated from hard plastic or alternative materials such as composites, metals, or hybrid structures, with manufacturing methods selected in accordance with the desired mechanical properties.

In certain embodiments, a single-unit de-blinding rod is provided, formed as a unitary body from polyurethane, elastomers, metal, or other suitable materials using molding, extrusion, casting, machining, or additive manufacturing techniques. In accordance with one aspect of the present disclosure, the unitary de-blinding rod comprises at least one trunk and a plurality of branches, each branch including an arm that extends to a distal end and is integrally formed with a connecting sleeve, wherein the connecting sleeve is configured to be wider than the arm. The trunk and branches are preferably constructed as a single, continuous piece of material.

In accordance with another aspect of the present disclosure, each connecting sleeve may extend to a distal end having a connection aperture therethrough and further comprises a recess along its longitudinal axis for receiving a trunk of an additional de-blinding rod. In preferred embodiments, the trunk and the arms of the branches are square in cross-section, and the trunk may additionally include a connection aperture therethrough. Each branch may further incorporate a sloped transition point between its arm and connecting sleeve to limit aggregate lodging. The unitary, single-piece body is preferably substantially solid to increase the overall mass of the de-blinding rod. The solid-body construction of the single unit de-blinding rod results in an assembly that is comparatively heavier than conventional de-blinding rods, thereby improving its ability to clear aggregate material during the screening process.

### BRIEF DESCRIPTION OF THE DRAWINGS

To more clearly describe the technical solutions of the examples of the de-blinding rod described herein, the figures required to be used for the examples will be briefly introduced below. It should be understood that the following figures only show some examples, and thus shall not be construed as limiting the scope of the disclosed de-blinding rod; and for a person skilled in the art, further relevant figures could also be obtained according to the figures without using inventive efforts.

FIG. 1 depicts a prior art de-blinding rod assembly.

FIG. 2A depicts a perspective view of a connecting sleeve of the prior art de-blinding rod assembly of FIG. 1.

FIG. 2B depicts an end view of the connecting sleeve of the prior art de-blinding rod assembly of FIG. 2A.

FIG. 3A depicts a perspective view of a unidirectional locking dowel for the de-blinding rod assembly in accordance with one or more embodiments of the subject matter disclosed herein.

FIG. 3B depicts a side view of the unidirectional locking dowel for the de-blinding rod assembly in accordance with one or more embodiments of the subject matter disclosed herein.

FIG. 4 depicts a top view of a portion of a de-blinding rod assembly mechanically connected using a plurality of the unidirectional locking dowels disclosed herein.

FIG. 5 depicts a top view of a de-blinding rod assembly mechanically connected using a plurality of the unidirectional locking dowels disclosed herein.

FIG. 6 depicts a top view of a single-piece unitary de-blinding rod in accordance with one or more embodiments of the subject matter disclosed herein.

FIG. 7 depicts an end view of a connecting sleeve of the unitary de-blinding rod of FIG. 6.

### DETAILED DESCRIPTION OF THE EMBODIMENTS

The following description and drawings are illustrative and are not to be construed as limiting. Numerous specific details are described to provide a thorough understanding of the disclosure. However, in certain instances, well-known or conventional details are not described to avoid obscuring the description. References to “one embodiment” or “an embodiment” in the present disclosure can be, but not necessarily are, references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting does not influence the scope and meaning of a term; the scope and meaning of a term are the same, in the same context, whether or not it is highlighted. It will be appreciated if the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or any exemplified term. Likewise, the disclosure is not limited to various embodiments given in this specification.

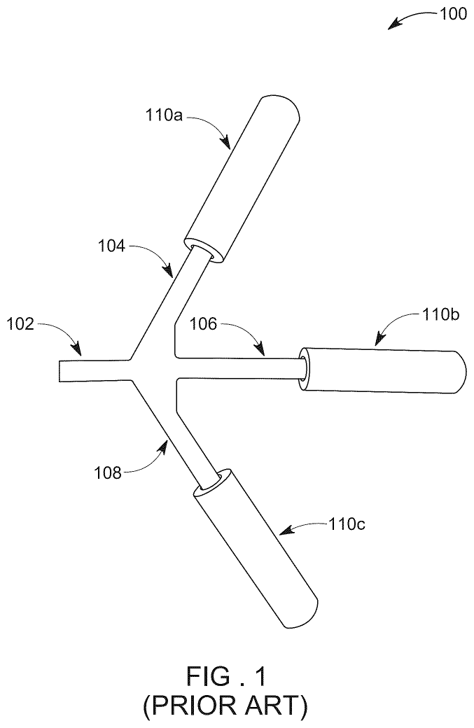

FIG. 1 illustrates a prior art de-blinding rod assembly. Referring to FIG. 1, de-blinding rod assembly 100 is representative of a conventional configuration and comprises a trunk portion 102 and branch portions 104, 106, and 108. Connecting sleeves 110a, 110b, and 110c are coupled to branch portions 104, 106, and 108, respectively. Each of the branch portions and connecting sleeves includes apertures (not shown) configured to receive dowels or locking pins that facilitate attachment of the connecting sleeves to the trunk and/or branch portions of the de-blinding rod assembly 100.

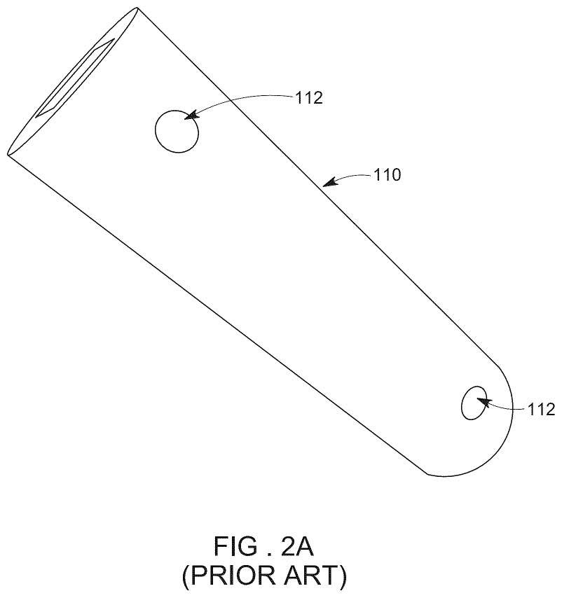

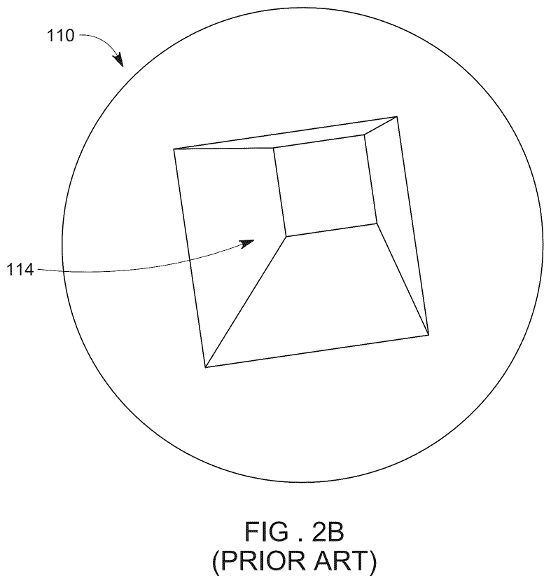

FIG. 2A illustrates a perspective view of a connecting sleeve of the prior art de-blinding rod assembly of FIG. 1. Referring to FIG. 2A, connecting sleeve 110 is depicted. Connecting sleeve 110 includes apertures 112 at opposing ends to receive dowels for connection to the trunk portion or to branch portions of the de-blinding rod assembly.

FIG. 2B illustrates an end view of connecting sleeve 110 of the prior art de-blinding rod assembly of FIG. 2A. Referring to FIG. 2B, connecting sleeve 110 includes a square-shaped bore extending through the length of the connecting sleeve. The square-shaped bore is dimensioned to correspond to the shape and size of the trunk portion and branch portions of the de-blinding rod assembly, thereby facilitating connection therewith.

These conventional de-blinding rods have several drawbacks. The rods often require assembly from multiple components, which adds to assembly time and associated costs. The dowels themselves tend to be simple pins relying on dimensional interference for a locking effect but may loosen or vibrate free over time, risking disassembly under operational vibration. Hollow or open designs in conventional rods can allow aggregate particles to lodge in corners or junctions, causing clogging and reduced screening efficiency. Additionally, conventional rods may be relatively lightweight or feature geometries that are less effective in clearing material from vibrating screens.

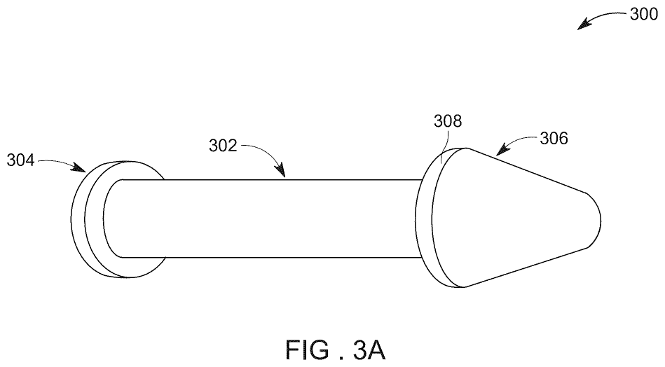

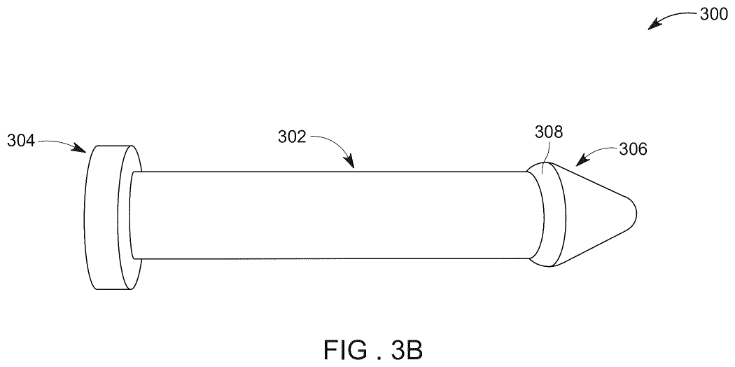

The accompanying FIGS. 3A through 7 illustrate the improved de-blinding rod assembly and unidirectional locking dowel in accordance with the present disclosure. According to one or more embodiments, FIGS. 3A and 3B illustrate a perspective view and side view, respectively, of an improved unidirectional locking dowel 300 for use in a de-blinding rod assembly. Referring to FIG. 3A, the locking dowel 300 comprises a shaft 302, a flat base portion 304 disposed at a first end of the shaft 302, and a tapered head or shouldered point 306 disposed at a second end of the shaft 302, opposite the flat base portion 304. As shown best in FIG. 3B, the flat base portion 304 has an outer diameter greater than the outer diameter of the shaft 302. Similarly, the tapered head may be a shouldered point 306 that includes a lip portion 308 proximal to the shaft and having an outer diameter greater than that of the shaft 302. The lip portion 308 serves as a locking surface, providing a mechanical barrier that prevents further movement once engaged within an aperture. The shouldered point 306 tapers from an enlarged diameter adjacent to the lip portion 308 to a reduced point distal from the shaft 302, thereby facilitating smooth initial insertion into the aperture and subsequent secure retention. In a preferred embodiment, the distance between the flat base portion 304 and the shouldered point 306 is approximately equal to the outer diameter of the connecting sleeve 110. Additionally, the shaft 302 has a diameter that is substantially equal to the diameter of the apertures 112. Preferably, the length of the shaft 302 closely matches the length of the aperture 112, ensuring that the shaft 302 fits securely within the aperture 112 along its length.

The dimensions of the locking dowel may be configured to correspond with those of conventional de-blinding rod assemblies, thereby enabling locking dowel 300 to be universally compatible with pre-existing assemblies and obviating any need for retrofitting. In an exemplary embodiment, the overall length of locking dowel 300 may be approximately 2.4 inches, of which the shaft 302 may account for approximately 1.77 inches. The flat base portion 304 may have a height of approximately 0.13 inches and a diameter of approximately 0.57 inches. The lip portion 308 of the shouldered point 306 may have a diameter of approximately 0.47 inches. The shaft 302 may have a diameter of approximately 0.39 inches, which is smaller than both the shouldered point 306 and the flat base portion 304. In a preferred embodiment, the difference between the outer diameter of the flat base portion 304 and the outer diameter of the shaft 302 may be approximately 2 mm, thereby facilitating secure retention of the locking dowel within the apertures of the de-blinding rod assembly.

This configuration permits unidirectional insertion of the locking dowel 300 through the apertures 112 of a connecting sleeve 110. Once fully inserted, the enlarged outer diameter of shouldered point 306 prevents the locking dowel 300 from retracting rearward through apertures 112, while the flat base portion 304 prevents forward movement through apertures 112. Therefore, upon full insertion into connecting sleeve 110, locking dowel 300 is secured in place and cannot be removed without a destructive force such as cutting, fragmenting, fracturing, or the like. Accordingly, such a configuration inhibits the locking dowel 300 from vibrating loose or becoming disengaged during operation of the de-blinding rod 500 assembly, as frequently occurs in conventional de-blinding rods.

In various embodiments, the locking dowel 300 may be formed of a hard plastic material using manufacturing techniques such as injection molding or additive manufacturing (e.g., three-dimensional printing). The particular hard plastic material may be selected based on mechanical properties, such as breaking strength, to ensure durability under vibrational loading. In other embodiments, locking dowel 300 may be fabricated from alternative materials exhibiting sufficient structural strength to resist fracture when employed in a vibrating aggregate processing machine. Such alternative materials may include, without limitation, fiber-reinforced polymers, composites, elastomers, metals such as aluminum, steel, or stainless steel, or hybrid materials combining polymeric and metallic constituents. The choice of material may be made in consideration of operational parameters, including vibration amplitude, load conditions, environmental exposure, and expected service life.

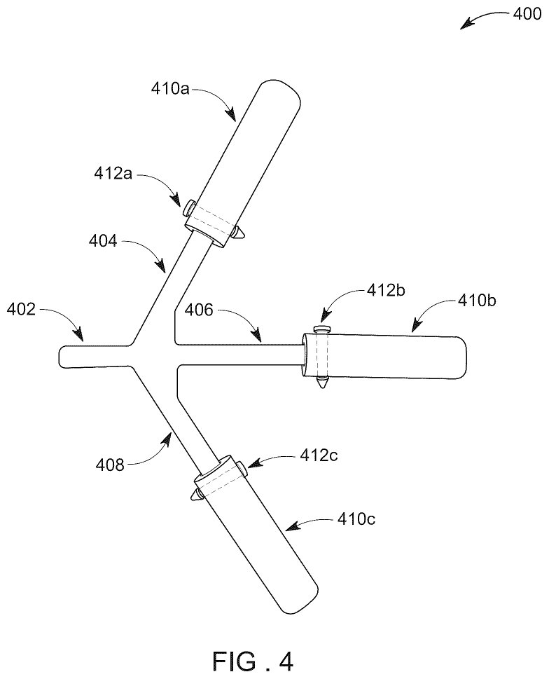

FIG. 4 illustrates a top view of a portion of a de-blinding rod 400 assembly mechanically secured together using a plurality of unidirectional locking dowels as described herein. Referring to FIG. 4, locking dowels 412a, 412b, and 412c are depicted as establishing locking connections between connecting sleeve 410a and branch 404, connecting sleeve 410b and branch 406, and connecting sleeve 410c and branch 408, respectively. As previously described, the structural configuration of locking dowels 412a, 412b, and 412c ensures that, once fully inserted, the dowels are resistant to vibrational displacement. Accordingly, the de-blinding rod 400 assembly remains in a secured, assembled state until intentional removal is effected, such as by severing, shearing, or otherwise intentionally removing the shouldered point 306 or flat base portion 304 of the dowels 412 to permit disassembly.

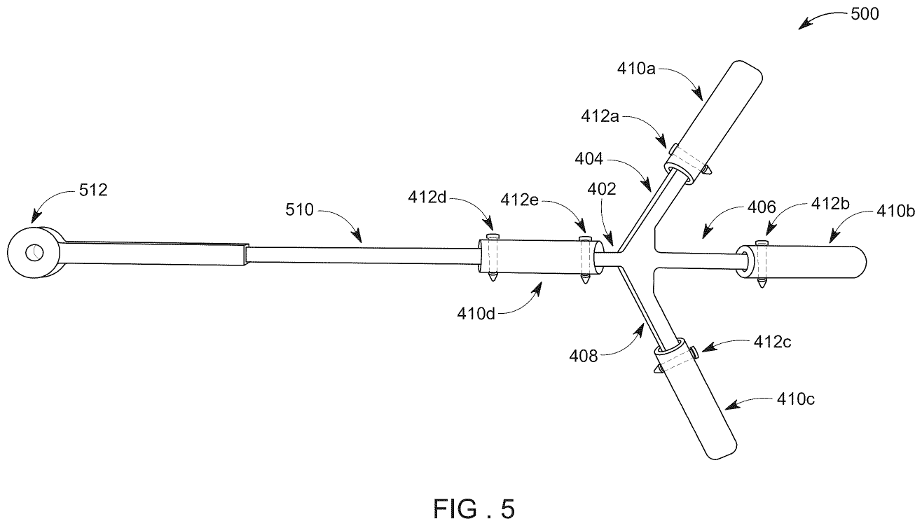

FIG. 5 illustrates a top view of the de-blinding rod assembly 500 of FIG. 4, further comprising an extension bar 510 coupled to trunk portion 402 by way of connecting sleeve 410d. Referring to FIG. 5, locking dowels 412d and 412e establish secure connections between trunk portion 402 and extension bar 510 through connecting sleeve 410d. Extension bar 510 may further include an attachment section 512 configured to interface the assembled de-blinding rod assembly 500 with a vibrating aggregate processing machine. In certain embodiments, attachment section 512 comprises a ring-shaped portion distal to the trunk portion 401 of the de-blinding rod assembly 500, although other geometries may be employed.

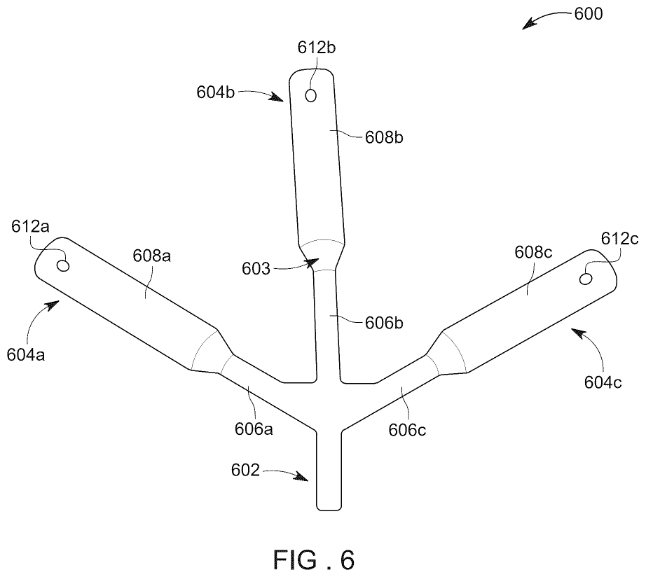

FIG. 6 illustrates a de-blinding rod 600 constructed as a single, substantially solid unitary body. Referring to FIG. 6, de-blinding rod 600 exhibits an overall configuration similar to that of de-blinding rod assembly 400 of FIG. 4. In contrast to the multi-component arrangement of de-blinding rod assembly 400, however, de-blinding rod 600 is formed or constructed as a substantially solid single-piece of material. The unitary de-blinding rod 600 may be sized for effective clearance of aggregate material and may be dimensioned to be substantially similar to conventional de-blinding rods. As a result, the unitary rod 600 may be interconnected with existing de-blinding rods and integrated into standard rod assemblies.

In various embodiments, unitary de-blinding rod 600 may be fabricated from polyurethane or other materials, including but not limited to other elastomers, thermoplastics, fiber-reinforced polymers, composites, metals such as aluminum or steel, hybrid polymer-metallic materials, or the like. Manufacturing techniques may include injection molding, compression molding, extrusion, casting, machining, or additive manufacturing processes such as three-dimensional printing, with the particular technique selected based on the chosen material and desired performance properties.

In a preferred embodiment, the unitary de-blinding rod 600 includes a trunk portion 602 and a plurality of branch portions 604a, 604b, and 604c. Each branch portion 604a, 604b, and 604c may include an arm 606a, 606b, and 606c that extends distally to form a connecting sleeve 608a, 608b, and 608c at an end distal from the trunk 602. The transition point 603 whereby the arm 606 of the branch 604 forms a connecting sleeve 608 may be, sloped, tapered or funnel shaped, as shown in FIG. 6. This tapering of the transition point 603 eliminates the right-angle junction seen in the de-blinding rod of FIGS. 1 and 4 and reduces the likelihood of aggregate material lodging within a right-angle junction between the branch and the connecting sleeve, as is observed in conventional blinding rods.

Each connecting sleeve of branch portions 604a, 604b, and 604c may include interconnection means such as apertures 612a, 612b, and 612c near distal ends thereof, thereby enabling interconnection between multiple unitary de-blinding rods 600 by way of the unidirectional locking dowels, or other suitable means for attachment, disclosed herein. The trunk portion 602 may also include at least one connecting aperture therethrough for interconnection with a second de-blinding rod assembly.

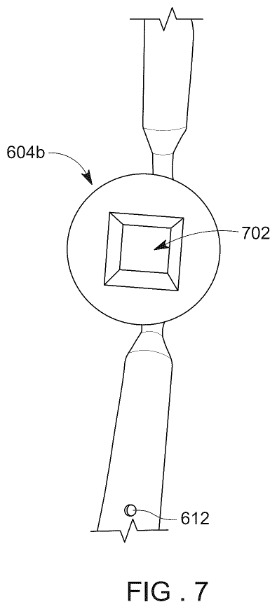

In certain embodiments, distal ends of 604a, 604b, and 604c may also comprise square-shaped openings or recesses 702 within a longitudinal axis of the connecting sleeve adapted to receive correspondingly-shaped trunk portions 602 of additional single-unit de-blinding rods 600, thereby enabling construction of a modular de-blinding bar. While square-shaped recesses 702 are illustrated herein, it is to be understood that other suitable geometries may be employed. As shown in FIG. 7, connecting sleeve 604b includes a recessed portion 702 adapted for receiving a trunk of another de-blinding rod. However, unlike the bores of connecting sleeve 110, the square-shaped recesses of de-blinding rod 600 may not extend through the entirety of the connecting sleeve, thereby increasing the mass and heft of the assembly and providing a more effective clearing of aggregate from the vibrating screens.

The unitary de-blinding rod 600 has many advantages over conventional de-blinding rods. And, although the de-blinding rod assembly 400 shown in FIG. 4 is improved over conventional rods, in some circumstances, the unitary de-blinding rod 600 may be preferred over the multi-component de-blinding rod assembly 400. For example, the unitary de-blinding rod 600 does not require separate assembly, thereby reducing installation time and eliminating the cost associated with locking dowels or other fasteners. The solid construction results in a comparatively heavier rod, enhancing the clearance efficiency by exerting greater force on material buildup during aggregate processing. Moreover, the unitary design eliminates joints or seams found in assembled rods, thereby reducing the risk of mechanical failure, loosening, or dislodgement under vibrational stress. This improved structural integrity enhances durability and operational reliability, minimizing maintenance and replacement frequency. Additionally, manufacturing the rod as a single piece allows for optimized geometric shaping, such as tapered or funnel-shaped transitions, which reduce material lodging and improve the flow characteristics of aggregate over the rod assembly.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims. While the invention has been described with respect to certain exemplary embodiments, the embodiments are intended to be illuminating rather than limiting. Modifications and changes may be made within the scope of the invention, which is defined by the appended claims.

What is claimed is:

1. A dowel for connecting portions of a de-blinding rod assembly for processing aggregate using a vibrating screen, the dowel comprising:
a shaft having an outer diameter;
a base at a first end of the shaft, wherein the base has an outer diameter that is larger than the outer diameter of the shaft; and
a tapered head at a second end of the shaft, wherein a portion of the tapered head has an outer diameter that is larger than the outer diameter of the shaft.

2. The dowel of claim 1, wherein the dowel is configured for unidirectional insertion into an aperture of the de-blinding rod assembly; and
wherein the base and the tapered head prevent lateral movement of the dowel within the aperture of the de-blinding rod assembly, thereby securely locking the dowel in place.

3. The dowel of claim 1, wherein the dowel semi-permanently interconnects components of the de-blinding rod assembly, thereby preventing the components from vibrating apart during use.

4. The dowel of claim 1, wherein the tapered head is a shouldered point comprising a lip portion proximal to the shaft, the lip portion having an outer diameter greater than the outer diameter of the shaft, thereby providing a mechanical barrier that prevents further movement once engaged within an aperture.

5. The dowel of claim 1, wherein the difference between the outer diameter of the base and the outer diameter of the shaft is approximately 2 mm.

6. The dowel of claim 1, wherein the outer diameter of the shaft is approximately equal to an outer diameter of a connection aperture of the de-blinding rod assembly.

7. The dowel of claim 1, wherein the length of the shaft is approximately equal to an outer diameter of a connecting sleeve of the de-blinding rod assembly.

8. The dowel of claim 1, wherein the dowel is configured to be resistant from vibrational displacement during normal operational conditions.

9. The dowel of claim 1, wherein the dowel is configured such that removal from the de-blinding rod assembly is prevented under normal operational conditions and can only be effected through the application of destructive force sufficient to sever, fracture, deform, or otherwise irreversibly alter the dowel or the de-blinding rod assembly.

10. A de-blinding rod assembly for processing aggregate using a vibrating screen, comprising:
at least one first portion comprising a trunk and a plurality of branches, wherein the trunk and branches each include a connection aperture therethrough;
a plurality of connecting sleeves, wherein each connecting sleeve includes at least one connection aperture, and wherein the each connecting sleeve includes a bore along a longitudinal axis; and
at least one dowel of claim 1, connecting one or more of the connecting sleeves to the at least one first portion through the apertures.

11. The de-blinding rod assembly of claim 10, wherein each of the trunk and the plurality of branches is square in cross-section.

12. The de-blinding rod assembly of claim 11, wherein the bore through each connecting sleeve is square in cross-section.

13. The de-blinding rod assembly of claim 10, wherein the first portion is constructed as a single piece.

14. The de-blinding rod assembly of claim 10, wherein the first portion is made of polyurethane.

15. The de-blinding rod assembly of claim 10, further comprising an extension bar connected by a connecting sleeve to the trunk of the first portion, wherein the extension bar includes a connection point for mechanically connecting to a vibrating screen assembly.

16. The deblending rod assembly of claim 10, wherein the base and the tapered head of the dowel prevent lateral movement of the dowel within the connection aperture, thereby securely affixing the connecting sleeves to the first portion of the de-blinding rod assembly, and thereby preventing the connecting sleeves and the first portion from vibrating apart during use.

17. A method of processing and screening aggregate, comprising the steps of:
providing the de-blinding rod of claim 10;
installing a plurality of the de-blinding rods across a vibrating screen; and
passing aggregate material over the screen for separation according to predetermined specifications.
